(19) United States
(12) Patent Application Publication
(10) Pub. No.: US 2007/0011711 A1
(43) Pub. Date: Jan. 11, 2007

(54) Method and apparatus for real-time distributed video analysis

(76) Inventors: Wayne Wolf, Princeton, NJ (US); I. Burak Ozer, Plainsboro, NJ (US); Tiehan Lv, Chandler, AZ (US); Changhong Lin, Princeton, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/474,848

(22) Filed: Jun. 26, 2006

Related U.S. Application Data
(60) Provisional application No. 60/693,729, filed on Jun. 24, 2005.

(51) Int. Cl. H04N 7/173

(52) U.S. Cl. 725/105

(57) ABSTRACT

The present invention describes a method and system for the real-time processing of video from multiple cameras using distributed computers using a peer-to-peer network, thus eliminating the need to send all video data to a centralized server for processing. The method and system use a distributed control algorithm to assign video processing tasks to a plurality of processors in the system. The present invention also describes automated techniques to calibrate the required parameters of the cameras in both time and space.

### CROSS-REFERENCE TO RELATED APPLICATION

This application claims the benefit of U.S. Provisional Application No. 60/693,729, filed Jun. 24, 2005. U.S. Provisional Application No. 60/693,729 is hereby incorporated herein by reference.

### FIELD OF THE INVENTION

The present invention relates generally to methods and apparatuses for the real-time processing of visual data by multiple visual sensing nodes connected via a peer-to-peer network.

### BACKGROUND OF THE INVENTION

Video and still cameras are used to monitor animate and inanimate objects in a variety of contexts including law enforcement and public safety, laboratory protocols, patient monitoring, marketing, and other applications.

The use of multiple cameras helps to address many issues in video processing. These include the challenges of surveillance of wide areas, three-dimensional image reconstruction, and the operation of complex sensor networks. While some have developed architectures and algorithms for real-time multiple camera systems, none have developed systems for distributed computing. Rather, prior art systems rely on centralized servers.

When analyzing video or images from multiple cameras, a central issue is combining the data from multiple cameras. Traditionally, multiple camera systems for video and image processing have relied on centralized servers. In this scheme, camera data is sent to one central server, or a cluster of servers, for processing. However, server-based processing of image/video data presents problems. First, it requires a high-performance network to connect the camera nodes to the one or more servers. Such a network consumes a significant amount of energy. Not only can a high-level of energy consumption result in environmental heating, but the amount of energy required to transmit video may be too high to be supported by battery-operated or other installations with limited energy sources. Second, in server-based processing systems, the transmitted video may be intercepted, tampered with, corrupted and/or otherwise abused.

Computers and other electronic devices allow users to both observe video output for activities of interest and to utilize processors to automatically or semi-automatically identify activities of interest. Recent technological advances in integrated circuits make possible many new applications. For example, a “smart camera” system is designed both to capture video input and, by way of its own embedded processor, to execute video processing algorithms. Smart cameras can perform various real-time video processing functions including face, gesture and gait recognition, as well as object tracking.

The use of smart cameras begins to address the problems presented by server-based systems by moving computation and analysis closer to the video source. However, simply arranging a series of smart cameras is not sufficient, as the data gathered and processed by these cameras must be collectively analyzed.

Thus, their remains a need for a secure, energy-efficient method for processing and analyzing video data gathered by a plurality of sources.

### SUMMARY OF INVENTION

The above-described problems are addressed and a technical solution is achieved in the art by a system and method for peer-to-peer communication among visual sensing nodes.

The present invention relates to a distributed visual sensing node system which includes one or more visual sensing nodes, each including a sensing unit and an associated processor, communicatively connected so as to produce a composite analysis of a target scene without the use of a central server. As described herein, the term “sensing unit”, is intended to include, but is not limited to a camera and like devices capable of receiving visual data. As described herein, the term “processor”, is intended to include, but is not limited to a processor capable of processing visual data. As described herein, the term “visual sensing node”, is intended to include, but is not limited to a sensing unit and its associated processor.

Embodiments of the present invention are advantageous in that they do not require the collection of image/video data to centralized servers.

Embodiments of the present invention employ a variety of image/video analysis algorithms and perform functions including, but not limited to, gesture recognition, tracking and face recognition.

Embodiments of the present invention include methods and apparatuses for analyzing video from multiple cameras in real time.

Embodiments of the present invention include a control mechanism for determining which of the processors performs each of the specific functions required during video processing.

Embodiments of the present invention include distributed visual sensing nodes, wherein the visual sensing nodes exchange data in the form of captured images to process the video streams and create an overall view.

Embodiments of the invention include the performance of at least some of the video processing in the processors located at or near the sensing units which capture the images. The image processing algorithms in each processor are broken into several stages, and the product of each stage is candidate data to be transferred to nearby camera nodes. The term “candidate data” is intended to include, but is not limited to, information collected and analyzed by a visual sensing node that may potentially be sent to another visual sensing node in the system for further analysis.

According to embodiments of the present invention, each visual sensing node receives captured and processed images, along with data from other visual sensing nodes in order to perform the processing function.

In embodiments of the present invention, data-intensive computations are performed locally with an exchange of information among the visual sensing nodes still occurring so that the data is fused into a coherent analysis of a scene.

In embodiments of the present invention, control is passed among processors while the system operates. As used herein, the term “control” is intended to include, but is not limited to, one or more mechanisms by which the visual sensing nodes cooperate to determine which visual sensing nodes will be responsible for forming which parts of the overall processing result.

Thus, embodiments of the present invention confer several advantages including, but not limited to, lower cost, higher performance, lower power consumption, the ability to handle more visual sensing nodes in a distributed visual sensing node system, and resistance to failures and faults.

Embodiments of the present invention collect the spatial coordinates and synchronize the individual time-keeping functions of the camera nodes in advance, and then calibrate the information in real time during the operation of the system.

According to embodiments of the present invention, the visual sensing nodes can be distributed either sparsely or densely around the field of interest, and the size of the field of interest can be of any size.

Embodiments of the present invention may utilize a variety of networks as the channel of communication among the visual sensing nodes, depending on the system architecture and communication bandwidth requirements. For example, the IEEE 802.3 Ethernet or the IEEE 802.11 family of wireless networks may be utilized, but additional network options are also possible.

Further, embodiments of the present invention afford users freedom in choosing the protocol to be used for the communication. Thus, users may utilize transmission control protocol (TCP) or user data protocol (UDP) over Internet protocol (IP) as the medium, or define their own transmission protocols. In determining an adequate protocol, those of ordinary skill in the art will take into account the size of the data being transmitted as well as the transmission power and delay.

Embodiments of the present invention may be applied to a variety of video applications, and while the following detailed description focuses on a gesture recognition system, those of skill in the art will recognize that the same methodology may be applied in other contexts as well.

### BRIEF DESCRIPTION OF THE DRAWINGS

The present invention will be more readily understood from the detailed description of the embodiments presented below considered in conjunction with the attached drawings, of which:

FIG. 1 is an illustration of a distributed visual sensing node system, including computers and visual sensing nodes;

FIG. 2 is a flow diagram of a system organization;

FIG. 3 is a flow diagram of the video processing step of FIG. 2;

FIG. 4 is a flow diagram of a single-visual sensing node gesture recognition component;

FIG. 5 is a flow diagram of the adaptation function of embodiments of the present invention;

FIG. 6 is a flow diagram of the gesture recognition component of FIG. 4, adapted to the distributed visual sensing nodes; and

FIG. 7 is a flow diagram of the temporal calibration procedure.

### DETAILED DESCRIPTION OF THE INVENTION

The present invention relates to a method and system for obtaining a comprehensive visual analysis of a target scene by means of a plurality of visual sensing nodes communicatively connected via a peer-to-peer network. As used herein, the term “peer-to-peer network” is intended to include, but is not limited to, a network configured such that a plurality of nodes communicate directly with one another by relying on the computing power and bandwidth of the participant nodes in the network rather than on a central server or collection of servers.

According to an embodiment of the present invention, the distributed visual sensing node system includes a plurality of visual sensing nodes comprising one or more sensing units with associated processors communicatively connected via a peer-to-peer network, wherein the system is configured to produce an overall view of a target scene.

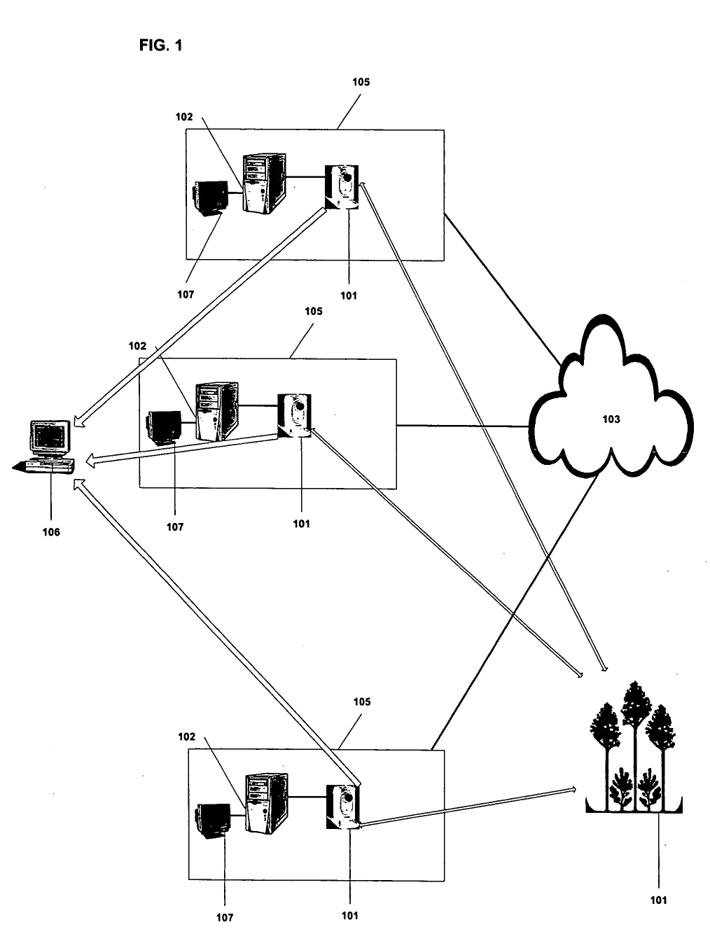

With reference to FIG. 1, the distributed visual sensing node system comprises a plurality of visual sensing nodes 105 communicatively connected via a peer-to-peer network 103. Each visual sensing node 105 comprises a visual sensing unit 101 communicatively connected to a processor 102. The sensing units 101 are used to capture video input. The processors 102 are used to perform various video processing tasks, as described in detail below. As described herein, the term “video input”, is intended to include, but is not limited to real-time information regarding a field of view, people or other objects of interest, herein referred to as the “target region.” 104. One type of visual sensing node 105 known to those of skill in the art is a “smart camera.” The visual sensing nodes 105 may communicate via any networking architecture 103 known to those of skill of the art, such as the Internet, IEEE 802.3 wired Ethernet, or IEEE 802.11 wireless network, as well as other communication methods known to those of skill in the art.

According to embodiments of the present invention, each visual sensing node 105 is configured to perform various single-sensing unit video processing tasks and to exchange control signals and data with other visual sensing nodes 105 regarding the captured images in order to process the video streams as a whole. As used herein, “control signals” are defined as, but not limited to, the one or more mechanisms by which the visual sensing nodes 105 cooperate to determine which visual sensing nodes 105 will be responsible for forming which parts of the overall processing result. As used herein, the term “overall processing result” is intended to include, but is not limited to, the final output rendered by the system and displayed on one or more of video displays 107. One or more of the visual sensing nodes 105 may include an associated video display 107. Users may observe the overall processing result directly from any one of the video displays 107 associated with the one or more the visual sensing nodes 105.

Further, embodiments of the present invention afford users freedom in choosing the protocol to be used in the communication. Thus, users may utilize transmission control protocol (TCP) or user data protocol (UDP) over Internet protocol (IP) as the medium, or define their own transmission protocols. In determining an adequate protocol, those of ordinary skill in the art will take into account the size of the data being transmitted and the transmission power and delay.

Additionally, some embodiments of the present invention include a host 106 for receiving processed results. Users may direct one or more visual sensing units 101 to send video streams to a host 106 for a short interval so the users may make instantaneous observations, for instance, when suspicious scenes are detected, for random monitoring, or for other purposes.

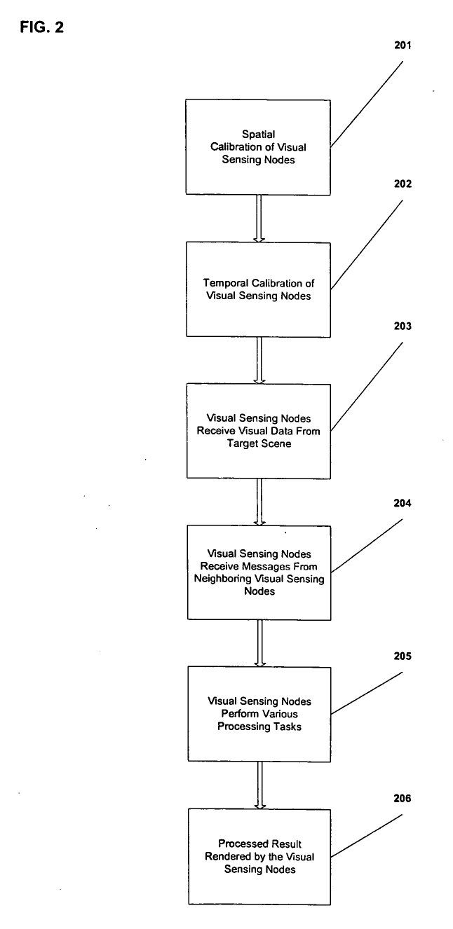

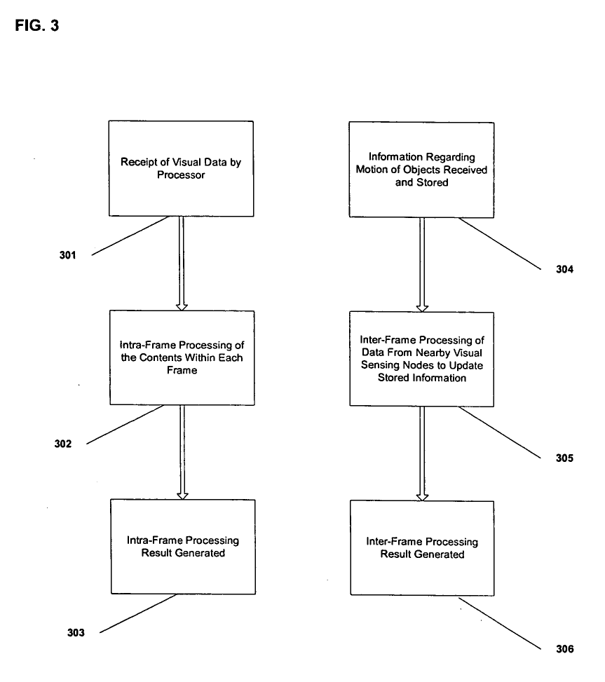

FIG. 2 illustrates the steps according to a method for obtaining a comprehensive visual analysis of a target region, according to an embodiment of the current invention. First, in steps 201 and 202, respectively, the visual sensing nodes 105 are spatially calibrated and temporally calibrated according to methods known to those of skill in the art, so that the relative locations of the visual sensing nodes 105 are established and to ensure synchronization of the clocks of the visual sensing nodes 105. Next, in steps 203 and 204, respectively, the visual sensing nodes 105 receive visual data from the target scene 104 and messages from neighboring visual sensing nodes 105 in the network. As used herein, the term “neighboring visual sensing nodes” is intended to include, but is not limited to, all of the other visual sensing nodes 105 in the system. As used herein, the term “visual data” is intended to include, but is not limited to, data collected by the individual visual sensing node's own sensing unit 101 regarding the target scene, as opposed to data regarding the target scene received from other visual sensing nodes 105 in the network. The term “messages” as it is used herein, is intended to include, but is not limited to data that is processed by one visual sensing node 105 in order to be communicated to other visual sensing nodes 105. Next, in step 205, the visual sensing nodes perform one or more video processing tasks by way of their processors 102 (described in detail with reference to FIG. 3) on both the visual data related to the target scene and the data received from neighboring visual sensing nodes 105. Finally, in step 206, an overall processing result is rendered.

With reference to FIG. 3, the video processing tasks performed by the processor 102 are divided into two categories: intra-frame processing (steps 301-303) and inter-frame processing (steps 304-306).

Referring to intra-frame processing, step 301 is the receipt of visual data captured by the local sensing unit 101 by the associated processor 102. Next, in step 302, the contents within each frame of the visual data are processed, and, in step 303, an intra-frame processing result is generated. As used herein, the term “intra-frame processing result” is intended to include, but is not limited to, the output rendered by intra-frame processing.

Intra-frame processing is the processing of the contents within a particular frame as opposed to the processing of a series of frames. According to an embodiment of the present invention, intra-frame processing steps can be performed using either pixel-based algorithms or compressed-domain algorithms. The term “pixel-based algorithms” is intended to include, but is not limited to those algorithms that use the color and position of the pixels to perform video processing tasks. The term “compressed-domain algorithm” is intended to include, but is not limited to those algorithms that are capable of compressing visual data directly.

Inter-frame processing, used in tracking and motion-estimation applications of the present invention, analyzes the movements of foreground objects within several consecutive frames in order to produce accurate processing results. First, in step 304, the processors 102 receive and store information regarding the motion of objects, now referred to as stored data. Next, in step 305, the processors use the messages from neighboring visual sensing nodes 102, now referred to as incoming data, to update the stored data. By updating the stored data in response to the incoming data, the processor generates an inter-frame processing result in step 306. As used herein, the term “inter-frame processing result” is intended to include, but is not limited to, the output rendered by inter-frame processing.

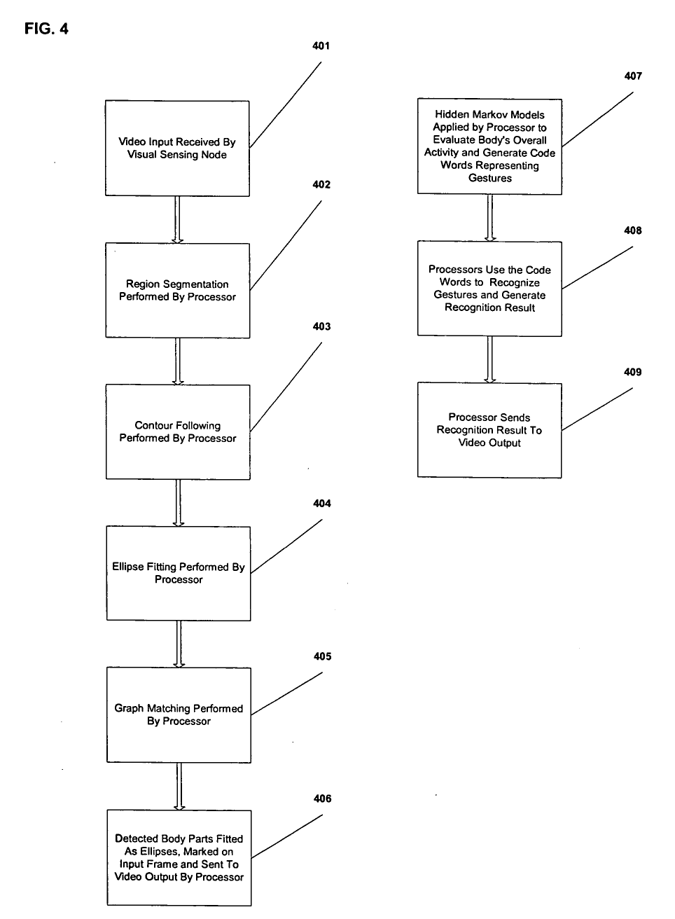

FIG. 4 illustrates an exemplary method, wherein a single-sensing node applies the processing steps described above in reference to FIG. 2 and FIG. 3 to perform recognition of a gesture made by an person or object located in the target scene. As it used herein, the term “gesture” is intended to include, but is not limited to movements made by discrete objects in the target scene.

First, in step 401, video input is received by the visual sensing node 105.

In step 402, region segmentation is performed, according to methods known to those of skill in the art, to eliminate the background from the input frames and detect the foreground regions, including skin regions. The foreground areas are then characterized into skin and non-skin regions.

In step 403, contour following is performed, according to methods known to those of skill in the art, to link the groups of detected pixels into contours that geometrically define the regions. Both region segmentation and contour following may be performed according to pixel-based algorithms.

In order to correct for deformations in image processing caused by clothing or objects in the frame or blocking by other body parts, ellipse fitting is performed according to methods known to those of skill in the art to fit the contour regions into ellipses, in step 404. The ellipse parameters are then applied to compute geometric descriptors for subsequent processing, according to methods known to those of skill in the art. Each extracted ellipse corresponds to a node in a graphical representation of the human body.

In step 405, the graph matching function is performed, according to methods known to those of skill in the art, to match the ellipses into different body parts and modify the video streams.

In step 406, detected body parts are fitted as ellipses, marked on the input frame and sent to the video output display 107.

The inter-frame processing aspect of the gesture recognition application can be further divided into two steps. First, in step 407, hidden Markov models (“HMM”), which are known to those of skill in the art, are applied by the processors 102 to evaluate a body's overall activity and generate code words to represent the gestures. Next, in step 408, the processors 102 use the code words representing the gestures to recognize various gestures and generate a recognition result. As used herein, the term “recognition result” is intended to include, but is not limited to the result of inter-frame processing which represents data concerning a particular gestures or gesture that can be read and displayed by the video output display 107 of embodiments of the present system. Finally, in step 409, the processors 102 send the recognition result to the video output display 107.

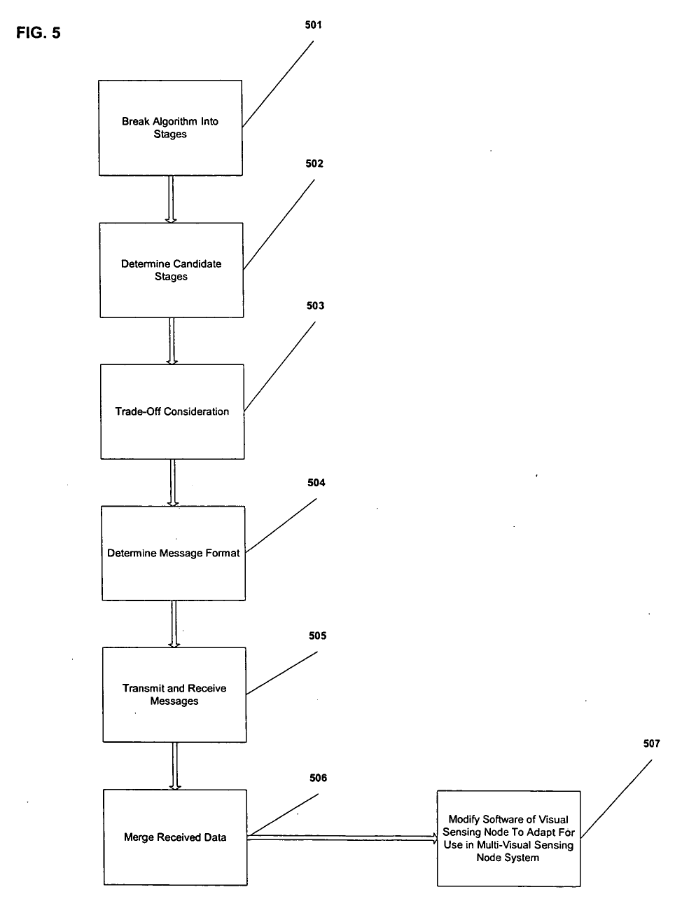

FIG. 5 illustrates an embodiment of the adaptation methodology of the present invention. As it is used herein, the term “adaptation methodology” is intended to include, but is not limited to, the process of adapting a system having a single visual sensory node 105 to a system having a plurality of visual sensing nodes. Essentially, in a multi-visual sensing node system, each visual sensing node 105 performs at least the same processing operations that it would in a single visual sensing node system. The difference is that, in a multi-visual sensing node system, the visual sensing nodes 105 process and exchange data before each stage of a divided algorithm. As it is used herein, the term “divided algorithm” is intended to include, but is not limited to, a visual sensing node's 105 algorithm which has been divided into several stages, according to methods known to those of skill in the art. The exchanged message is then taken into account by the stages afterward and integrated an overall view of the system

First, in step 501, the single visual sensing node's algorithm is divided into several stages based on its software architecture, according to methods known to those of skill in the art. Next, in step 502, it is determined during which of the stages or stages the visual sensing nodes will exchange messages. Next, in step 503, it is determined what stage or stages the exchange messages should be integrated by considering the trade-offs among system performance requirements, communication costs and other application-dependent issues. Next, in step 504, the format of the messages is determined. Then, in step 505, the software of a visual single sensing node 105 is modified to collect the information needed to be transferred and to transmit and receive the messages through the network. Next, in step 506, in order to minimize changes to the software, after the visual sensing nodes 105 receive data in the form of messages from neighboring visual sensing nodes 105, the visual sensing nodes merge the data with the data concerning the target scene collected from their own visual sensing units 102, if possible. Finally, in step 507, the software of the visual sensing nodes 105 is modified to adapt it for use in multi-visual sensing node system.

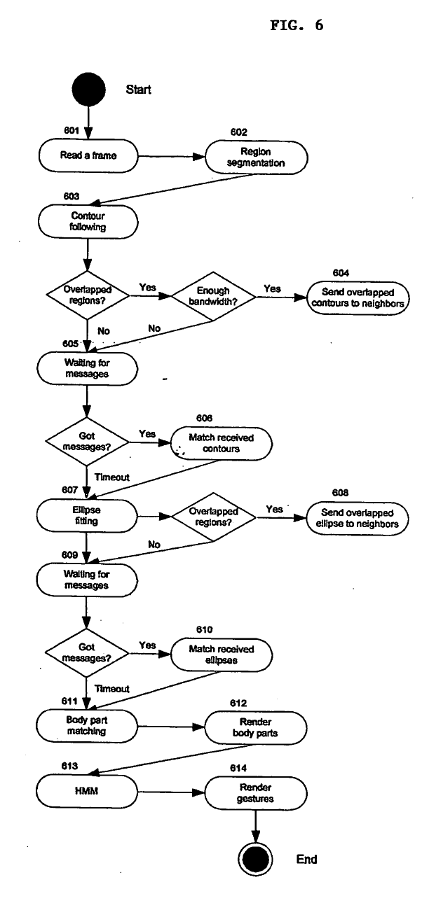

FIG. 6 illustrates an embodiment of a multi-sensing node gesture recognition system. This system is obtained by applying the adaptation methodology illustrated in FIG. 5 to the gesture recognition system illustrated in FIG. 4.

First, in step 601, the each of the visual sensing nodes 105 receives a frame of visual data from the target scene. As it used herein, the term “frame of visual data” is intended to include, but is not limited to one of a series of still images which, together, provide real-time information regarding the target scene. Then, in steps 602 and 603, each of the visual sensing nodes 105 performs region segmentation 402 and contour following 403 on the frame of visual data. In step 604, if there are any regions of overlapping contours between the frames of visual data collected by neighboring visual sensing nodes 105 and there is sufficient bandwidth available in the network at that point in time, each of the visual sensing nodes 105 sends the overlapping contours to the neighboring visual sensing nodes 105. Next, in steps 605 and 606, respectively, each of the visual sensing nodes waits to determine if there are any incoming messages from neighboring visual sensing nodes, and merges the contour data with the data regarding the target scene that it had gathered by means of its own visual sensing unit 102. Then, in steps 607 and 608, each of the visual sensing nodes performs ellipse fitting on the contour points and sends the overlapping ellipse parameters to neighboring visual sensing nodes that have a smaller bandwidth. Then, in steps 609 and 610 each of the visual sensing nodes waits again to determine if there are any incoming messages from other visual sensing nodes and merges the ellipse parameters. Next, in steps 611-613, each of the visual sensing nodes matches the ellipses to different body parts and uses hidden Markov models (HMM) to determine specified gestures. Finally, in step 614 the recognized gestures are rendered to the video output 107 and each of the visual sensing nodes goes into an idle state waiting to restart when the data regarding the next frame of visual data arrives.

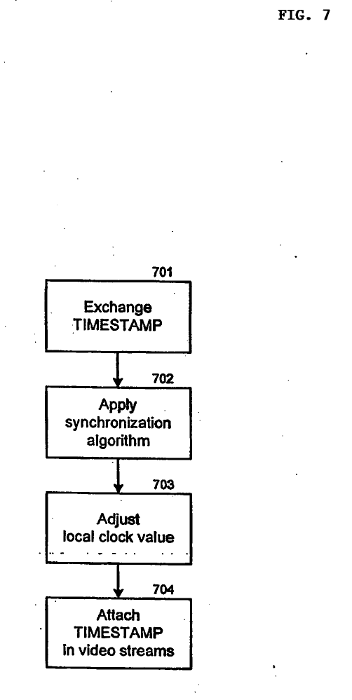

FIG. 7 illustrates the synchronization process according to the method depicted in FIG. 2 for obtaining a comprehensive visual analysis of a field of view. First, in step 701, each visual sensing node 105 exchanges timestamps with neighboring visual sensing nodes 105. Next, in step 702, a synchronization algorithm is applied which is known to one having ordinary skill in the art, such as, for example, a Lamport algorithm or a Halpern algorithms. Next, in step 703, individual visual sensing nodes utilize the synchronization results to adjust their own clock values. Finally, in step 704, timestamps are attached to the video streams, and used to maintain synchronization of the data messages.

It is to be understood that the above-described embodiments are merely illustrative of the present invention and that many variations of the above-described embodiments can be devised by one skilled in the art without departing from the scope of the invention. It is therefore intended that such variations be included within the scope of the following claims and their equivalents.

What is claimed is:

1. A system for analyzing a target scene, comprising:
a plurality of visual sensing nodes each comprising at least one visual sensing unit for capturing visual data relating to the target scene and an associated processor for intra-frame processing and inter-frame processing of the captured data to form at least one message; and
a peer-to-peer network communicatively connecting at least two of said visual sensing nodes to enable the at least one message from each node to be compared with each other to form an overall processing result.

2. The system of claim 1, further comprising at least one control signal by which the visual sensing nodes cooperate to determine which visual sensing nodes will be responsible for forming which parts of the overall processing result.

3. The system of claim 1, wherein the plurality of visual sensing nodes are smart cameras.

4. The system of claim 1, wherein the at least one visual sensing unit is a camera.

5. The system of claim 1, wherein the intra-frame processing operation utilizes a pixel-based algorithm.

6. The system of claim 1, wherein the intra-frame processing operation utilizes a compressed-domain algorithm.

7. The system of claim 1, wherein the intra-frame processing includes the steps of region segmentation, contour following, ellipse fitting and graph matching.

8. The system of claim 1, wherein the at least one processing result is distributed among the plurality of visual sensing nodes in response to an overlap among the at least one processing result of the plurality of visual sensing nodes.

9. The system of claim 8, wherein the each of the plurality of visual sensing nodes merges the at least one processing result from other of the plurality of visual sensing nodes with its own at least one processing result.

10. The system of claim 1, wherein the inter-frame processing further comprises the sub-steps of (a) applying hidden Markov models in parallel to generate code words representing gestures of at least one object and (b) using the code words to communicate information regarding the gestures of the at least one object to the output.

11. A method for analyzing a target scene, comprising
capturing visual data via a plurality of visual sensing nodes;
performing at least one intra-frame processing operation and at least one inter-frame processing operation on the visual data to form at least one message;
distributing, via a peer-to-peer network, the at least one message among the plurality of visual sensing nodes to be compared with each other to form an overall processing result.

12. The method of claim 11, wherein the visual sensing nodes cooperate to determine which visual sensing nodes will be responsible for forming which parts of the overall processing result via at least one control signal.

13. The method of claim 12, wherein the one or more mechanisms are control signals.

14. The method of claim 11, wherein plurality of visual sensing nodes are smart cameras.

15. The method of claim 11, wherein the at least one visual sensing unit is a camera.

16. The method of claim 11, wherein the intra-frame processing operation utilizes a pixel-based algorithm.

17. The method of claim 11, wherein the intra-frame processing utilizes a compressed-domain algorithm.

18. The method of claim 11, wherein the intra-frame processing includes the steps of region segmentation, contour following, ellipse fitting, and graph matching.

19. The method of claim 11, wherein the at least one processing result is distributed among the plurality of visual sensing nodes in response to an overlap among the at least one processing result of the plurality of visual sensing nodes.

20. The method of claim 11, wherein the each of the plurality of visual sensing nodes merges the at least one processing result from other of the plurality of visual sensing nodes with its own at least one processing result.

21. The method of claim 11, wherein the inter-frame operation further comprises the sub-steps of (a) applying hidden Markov models in parallel to generate code words representing gestures of at least one object and (b) using the code words to communicate information regarding the gestures of the at least one object to the output.
